(19) United States
(12) Patent Application Publication
(10) Pub. No.: US 2025/0232134 A1
(43) Pub. Date: Jul. 17, 2025

(54) CONVERSATIONAL LANGUAGE MODEL BASED CONTENT RETRIEVAL

(71) Applicant: Amazon Technologies, Inc., Seattle, WA (US)

(72) Inventors: Girish Shekhar, Seattle, WA (US); Zohar Karnin, Koranit, NJ (US)

(21) Appl. No.: 18/540,465

(22) Filed: Dec. 14, 2023

(51) Int. Cl. G06F 40/40; G06F 40/284; G06F 40/295

(52) U.S. Cl. CPC G06F 40/40; G06F 40/284; G06F 40/295

(57) ABSTRACT

Devices and techniques are generally described for LM-based content retrieval. First query data including a first request related to first content may be received. First action data associated with the first query data may be determined. First prompt data including a representation of the first query data and data representing the first action data may be generated. The first prompt data may instructs a first LM to recognize entities in the first query data relevant to the first action data. The first LM may determine a first recognized entity from the first request. The first recognized entity may be associated with the first content. A request to resolve the first recognized entity may be generated. A first resolved entity for the first recognized entity may be determined. The first LM may generate first instructions to perform the first action data using the first resolved entity.

### BACKGROUND

People can interact with computing devices using spoken commands. In some systems, a “wakeword” is used to activate functionality. Natural language processing is used to transform the spoken requests that follow into a computer directive for performing a task.

### BRIEF DESCRIPTION OF DRAWINGS

FIG. 1 is a block diagram illustrating an example language model (LM) based content retrieval system, in accordance with various aspects of the present disclosure.

FIG. 2 depicts an example LM-based natural language processing flow, in accordance with various aspects of the present disclosure.

FIG. 3 depicts a table including input utterances and various intermediate result data determined for the utterance by the LM-based content retrieval system of FIG. 1, in accordance with various aspects of the present disclosure.

FIG. 4 is a block diagram showing an example architecture of a network-connected device that may be used in accordance with various embodiments described herein.

FIG. 5 is a block diagram showing an example architecture of a computing device that may be used in accordance with various embodiments described herein.

FIG. 6 is a flow chart illustrating an example process for LM-based content retrieval, in accordance with embodiments of the present disclosure.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Devices with integrated processing capabilities are often configured with network communication capability and/or other computing functions allowing the devices to send data to and/or receive data from other devices. In some examples, such devices may include voice-enabled personal assistants, such as computer-implemented conversational agents, and/or other natural language processing interfaces that may be used to control the devices, answer questions, communicate with other people/devices, and/or otherwise interact with the devices and/or other devices. As such devices become more and more prevalent in both the home, office, public spaces, quasi-public spaces (e.g., hotels, offices, retail spaces), and elsewhere generally, and as the technology matures, new services and features are being developed. For instance, in some cases devices may be paired or otherwise grouped together with one another to enable certain functionality. For example, a device that includes voice-based personal assistant functionality may be paired with a device including a display so that spoken commands may be used to control content output by the display device. In another example, content may be transferred from one device to another device in response to user requests and/or other triggering events (e.g., If This Then That (IFTTT) recipes, presence information, etc.).

Some natural language processing flows may employ one or more language models (LMs) in order to process natural language requests. Colloquially, some LMs may be referred to as “large” language models (LLMs) based on a number of parameters learned by the models during training. An LM is an artificial intelligence (AI) model that may be capable of processing and generating human-like text based on the latent information it has learned from vast amounts of training data. The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to understand and generate more natural-sounding text (relative to previous approaches). LMs are typically trained on massive datasets that include a wide variety of text from various sources, enabling the LMs to understand grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training.

In some cases, generative LMs may hallucinate certain information and/or may generate output that does not conform to existing external logic, rules, regulations, etc. For example, an LM-powered voice assistant may be asked to reserve a seat for a particular movie. Using existing tools (e.g., a movie reservation API), the LM may determine the closest theater showing the movie and may reserve a seat for the movie at the closest theater. However, in this example the theater may be 100 miles from the requesting user's current location and therefore may be inconvenient. In another example, a user may want to order a particular item or add a particular item to cart. There may be existing logic that requires that prior to adding an item to a cart that a verification be made that the item is currently in stock. However, due to the probabilistic nature of LMs, the LM-powered voice assistant may not verify whether the item is in stock before modifying the user's container data (e.g., modifying website/web app data to add an instance of the item to a virtual cart associated with the user account).

Accordingly, in some instances it may be useful to ensure that the output generated by an LM conforms to some predefined set of rules, logic, regulations, etc. As such, in some examples described herein, action data comprising predefined tools, workflows, and/or subgraphs that conform to the relevant rules, logic, regulations, etc., are described. For example, action data may include a set of one or more predefined tasks defined for compliance with a set of rules Actions may comprise action schema data defining the tasks within an action. Actions may be associated with various input parameters that may be optional or required in order for the action to be executed. For example, some actions may have an optional identity input, where the identification of a specific account making the request may change the nature of the action being performed and/or of the account data being modified. In some further examples, actions may have an optional target endpoint input parameter defining the particular target (e.g., a predefined data structure) where the action should be taken or to which the action should be transferred. In some other examples, in order to take an action, various entities referred to by the user input may need to be resolved (e.g., in order to determine the entity/entities on which the action should be applied/performed). For example, content retrieval actions require entity resolution in order to determine the content to be retrieved. Action data may generally represent a set of tools (e.g., compute services, sub-graphs, workflows, etc., to which an LM may be given access to in order to potentially complete a requested task. In various examples, a shortlister may be used to determine a subset of actions (among a larger set of action data) that may be most likely to be relevant to a given input query. The subset of actions may be provided to the LM (in the prompt) and the LM may select from among the subsets in deciding how best to respond to the input query and/or what intermediate tasks should be performed.

Described herein is an LM-based content retrieval system that can be used in a conversational manner to perform actions that comply to existing rules, regulations, logic, while still harnessing the power of the LM to resolve entities implicated by the input request, determine the appropriate steps needed to handle complex input requests, and respond to the user in a conversational manner.

In some examples, a first LM-based natural language processing system may initially be used to process an input user request. The first LM-based natural language processing system may conceptually be thought of as a “generalist” that receives a user request and may either respond directly or determine that the request may be better handled by one or more domain-specific systems. As described above, there may be certain user requests that implicate actions that should be performed in a somewhat deterministic way in order to avoid unwanted results due to the probabilistic nature of LM processing. Accordingly, if the input user request implicates such a specialized domain, the first LM-based natural language processing system may pass the input request (and the relevant contextual data determined for the input request) to the more specialized domain, such as the LM-based content retrieval system described herein. In some examples, input requests may comprise natural language requests. However, input requests may include one or more different or additional modalities. For example, the input request may be in the form of video, audio, natural language (text, speech), structured data, and/or some combination thereof.

In some examples, generalist LM-based natural language processing may generate prompt data for a given input request (e.g., a text transcription of a given spoken request, generated using automatic speech recognition (ASR)). The prompt data may be augmented with various context data (a process sometimes referred to as “grounding”) and may be input into the LM. The LM may be trained to output a text-based action plan which may be formatted into a series of computer-executable actions (including API calls to various subsystems) that may be executed in order to process the natural language request. In various examples, an LM-based processing flow may be a recursive process wherein the initial action plan may be executed (e.g., by making various API calls to API providers to receive results/responses), and the responses may be used to generate updated LM prompts which may then be input into the LM for generation of an updated action plan. For example, a user may request “What is the best restaurant located nearest to the tallest mountain in California?” The prompt data generated for this request may instruct the LM to break the request down into a number of sub-tasks for solving the problem. The prompt data may also include various other context such as a device ID of a device used to input the request, time of day, day of year, account ID, previous turns in a current dialog session, etc.

The LM may generate a natural language output action plan indicating that, in order to solve the problem of the request, it needs to 1) determine the tallest mountain in California, 2) determine restaurants that are near the tallest mountain in California, and 3) determine rankings for these restaurants. An action plan generator may take the natural language output of the LM and may generate a series of computer-executable API calls to retrieve the information from various external computer-implemented services. For example, the action plan may specify a first API call to an API of a question-and-answer service (e.g., get_answer (“What is the tallest mountain in [location_name]”, location_name (location=“California”)) where the API takes as input the question and a location name (e.g., a “slot” value) as input parameters. An action plan executor may execute the API call and may receive result data indicating that Mount Whitney is the tallest mountain in California. Thereafter, the result may be passed as input to a different API used to retrieve restaurants near a particular location. In this case, the restaurant-retrieval API may take the location (e.g., Mount Whitney) as the input parameter. In an example, upon receiving a list of restaurants near Mount Whitney, updated prompt data may be generated by the LM-based natural language processing system. For example, the updated prompt may include the previous prompts, actions, and results along with a new text prompt of “Provide a ranked list of the five best restaurants among [list_of_restaurants_returned_by_restaurant_retrieval_API].” The LM may generate the list (e.g., using a restaurant ranking API) and may determine, using the latent information learned by the LM during training, that the result answers the initial user-input request. Accordingly, recursion may end and the LM may output the ranked list of restaurants.

As described above, in some cases, a generalist LM-based natural language processing flow may determine that the input request is best handled by a domain-specific “specialist” LM-based natural language processing flow, such as the LM-based content retrieval system 100 described below. In some examples, the generalist LM-based natural language processing flow may generate an API call to an API of the domain-specific LM-based natural language processing flow. The API call may pass the input request, context data (e.g., previous turns of dialog, actions already taken (such as an LM output action plan, etc.) via the API call to the domain-specific LM-based natural language processing flow.

In some further examples, a generalist natural language processing flow may not be LM-powered, but may instead use various other approaches for natural language processing. Automatic speech recognition (ASR) is a field of computer science, artificial intelligence, and linguistics concerned with transforming audio data associated with speech into text data and/or other ASR output data representative of that speech. In a voice assistant context, such as those described herein, ASR may be used to transform spoken utterances into text that can then serve as the input to an LM or other language model (e.g., natural language understanding (NLU), which is a field of computer science, artificial intelligence, and linguistics concerned with enabling computers to derive meaning from text input containing natural language, resulting in specific executable command data (e.g., intent data) or other type of instructions). Text-to-speech (TTS) is a field of computer science, artificial intelligence, and linguistics concerned with enabling computers to output synthesized speech. ASR, language models, and TTS may be used together as part of a natural language processing system. As used in, natural language input data (e.g., input user request data) may comprise audio data (e.g., representing a user request or command), text data, and/or other representation data representing natural language for input into a natural language processing system.

The various techniques described herein may be used in a variety of contexts, including in natural language processing enabled devices (e.g., devices employing voice control and/or speech processing “voice assistants”) and/or systems. Examples of speech processing systems and/or voice-enabled personal assistants include the Siri system from Apple Inc. of Cupertino, California, voice-enabled actions invoked by the Bard assistant or the Google Assistant system from Google LLC of Mountain View, California, Dragon speech recognition software or the Copilot system from Microsoft of Redmond, Washington, the Alexa system from Amazon.com, Inc. of Seattle, Washington, etc. Other examples of smart home devices and/or systems that may use the various content-based voice targeting techniques described herein may include Google Nest Smarthome products from Google LLC, HomeKit devices from Apple Inc., various smart doorbells (e.g., with integrated cameras and/or natural language processing capability), etc. For example, some models of Ring camera-integrated doorbells include Alexa speech processing functionality to allow users to have a virtual assistant interact with people at the door to take messages, etc.

Natural language processing enabled devices may include one or more microphones (e.g., far-field microphone arrays) used to transform audio into electrical signals. Speech processing may then be performed, either locally by the speech processing enabled device, by one or more other computing devices communicating with the speech processing enabled device over a network, or by some combination of the natural language processing enabled device and the one or more other computing devices. In various examples, natural language processing enabled devices may include and/or may be configured in communication with speakers and/or displays effective to output information obtained in response to a user's spoken request or command, and/or to output content that may be of interest to one or more users.

Storage and/or use of data related to a particular person or device (e.g., device identifier data, device names, names of device groups, contextual data, and/or any personal data) may be controlled by a user using privacy controls associated with a speech processing enabled device and/or a companion application associated with a speech processing enabled device. Users may opt out of storage of personal, device state (e.g., a paused playback state, etc.), and/or contextual data and/or may select particular types of personal, device state, and/or contextual data that may be stored while preventing aggregation and storage of other types of personal, device state, and/or contextual data. Additionally, aggregation, storage, and use of personal, device state, and/or contextual information, as described herein, may be compliant with privacy controls, even if not legally subject to them. For example, personal, contextual, device state, and other data described herein may be treated as if it was subject to acts and regulations, such as the Health Insurance Portability and Accountability Act (HIPAA) and the General Data Protection Regulation (GDPR), even if it is not actually subject to these acts and regulations. In various examples, the device and/or device group names and/or any data captured by such devices may be used only in accordance with user permission, in compliance with any relevant laws and/or policies. Additionally, users may opt out of data collection, and/or may opt to delete some or all of the data used by the various techniques described herein, even where deletion or non-collection of various data may result in reduced functionality and/or performance of various aspects of the systems described herein.

In various examples, a natural language processing enabled device may include a wakeword detection component. The wakeword detection component may process audio data captured by microphones of the speech processing enabled device and may determine whether or not a keyword and/or phrase, which are collectively sometimes referred to herein as a “wakeword”, is detected in the audio data. In some examples, when a wakeword is detected, the speech processing enabled device may enter a “sending mode,” “audio capturing mode,” and/or other type of processing mode in which audio detected by the microphones following the wakeword (e.g., data representing user request data spoken after the wakeword) may be sent to natural language processing computing component(s) (either locally or remotely) for further natural language processing (e.g., ASR, NLU, LM inference, etc.). In various examples, the wakeword detection component may be used to distinguish between audio that is intended for the natural language processing system and audio that is not intended for the natural language processing system.

Machine learning techniques, such as those described herein, are often used to form predictions, solve problems, recognize objects in image data for classification, etc. In various examples, machine learning models may perform better than rule-based systems and may be more adaptable as machine learning models may be improved over time by retraining the models as more and more data becomes available. Accordingly, machine learning techniques are often adaptive to changing conditions. Deep learning algorithms, such as neural networks, are often used to detect patterns in data and/or perform tasks.

Generally, in machine learned models, such as neural networks, parameters control activations in neurons (or nodes) within layers of the machine learned models. The weighted sum of activations of each neuron in a preceding layer may be input to an activation function (e.g., a sigmoid function, a rectified linear units (ReLu) function, etc.). The result determines the activation of a neuron in a subsequent layer. In addition, a bias value can be used to shift the output of the activation function to the left or right on the x-axis and thus may bias a neuron toward activation.

Generally, in machine learning models, such as neural networks, after initialization, annotated training data may be used to generate a cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is often referred to as back propagation.

Transformer models are machine learning models that include an encoder network and a decoder network. LMs are often implemented using transformer models. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions (e.g., action plan generation for an LM-based natural language processing flow, etc.). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights Wo, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{Q {K}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place—in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

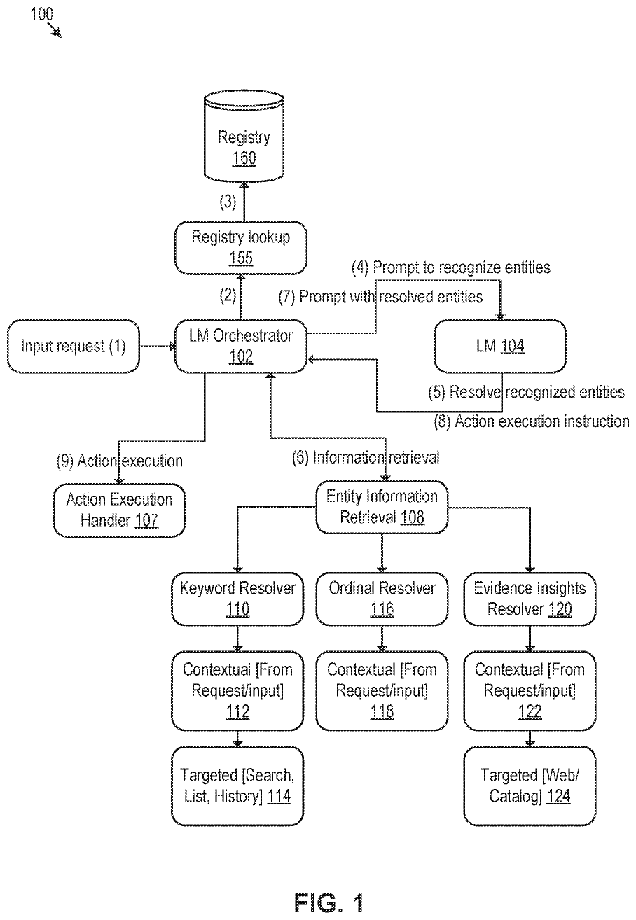

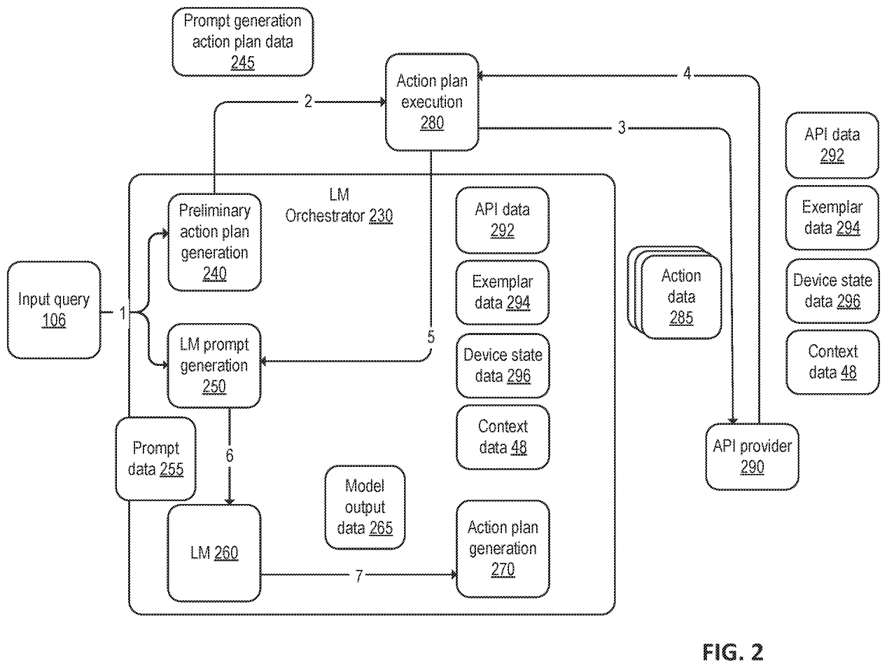

FIG. 1 is a block diagram illustrating an example LM-based content retrieval system 100, in accordance with various aspects of the present disclosure. The LM-based content retrieval system 100 may be an example of a domain-specific processing system. As such, the input request (step (1)) may be passed to the LM-based content retrieval system 100 from a general natural language processing system, such as the LM-based natural language processing system described in reference to FIG. 2. The input request may include text and/or audio representing the user utterance as well as contextual data (e.g., device state data, account data, previous turns of dialog, previous LM output from the current dialog session, etc.). In various examples, the general natural language processing system may determine that the input request is best served by the LM-based content retrieval system 100 (e.g., based on exemplar data and/or API description data describing the various functionalities of the LM-based content retrieval system 100).

LM orchestrator 102 may receive the input request and may send the input request to a registry lookup component (step (2)) to search registry 160. Registry 160 may be a data store that stores various account information and/or action data, as described herein. In various examples, the LM orchestrator 102 may include computer executable instructions that may cause the LM orchestrator 102 to execute the various steps described herein. In such a case, the “steps” refer to computer instructions to cause the various components of the LM-based content retrieval system 100 to perform the various actions described in reference to FIG. 1.

The registry lookup component 155 may include a search engine that may take the input request as an input and may generate query data that may be used to search the registry 160. In some examples, the registry lookup component 155 may comprise an encoder effective to encode the input request into a high dimensional vector that may then be used to perform a semantic search in the high dimensional vector space. The registry 160 may store various account information (e.g., data identifying different accounts and/or users of different accounts), action data, available targets, and/or available endpoints. The available targets and/or endpoints may be specific to a particular user account. Accordingly, in some examples, account identifier data (e.g., metadata included in the input request) may be used to search an account specific registry 160 for available endpoints and/or targets for that account. However, action data may be agnostic to any given account.

Action data may generally describe actions that may be performed by the LM-based content retrieval system 100. Each action may comprise a workflow of a series of sub-actions that are performed in order to accomplish the action. The intuition behind storing such predefined action data may be to ensure that the action performed conforms to guardrails (e.g., rules, regulations, enterprise logic, etc.) to avoid a situation where an LM performs an action that is contrary to such guardrails. However, as described below, the power of LM 104 may still be harnessed to resolve entities relevant to both the input request and the retrieved action data, as well as to generate action execution instructions in a way that provides a natural, conversational experience to the user. Each distinct action may comprise its own schema data, required and/or optional inputs, etc. As described below, the LM 104 may be used to recognize and resolve the various entities in the input request given the action data retrieved at step (3). Additionally, the LM 104 may determine the required entities for the retrieved action data, which may be missing from the input request and may prompt the user for such missing entity information. As previously described, in some examples, a shortlist of actions (e.g., available tools and/or actions that the LM 104 may use to respond) may be specifically determined for the input query (e.g., using semantic search) and may be provided to the LM 104. The LM 104 may perform inference to determine which actions should be used in responding to the input request. However, in other examples, data indicating all available action data may be provided to the LM 104 (as part of the prompt) and the LM 104 may determine which actions may be most appropriate from among those actions in responding to the input request.

Available endpoints refers to a set of devices associated with the input request (e.g., with a particular account ID) on which the requested action may be carried out. For example, if the user requests “play my favorite song,” there may be two smart speakers associated with the user's account. One of the two smart speakers may receive the spoken input request, while the other may be in an idle state. Each of the two devices may represent available endpoints that are associated with the user's account.

Available targets refer to data structures on which the action may be executed. For example, the user may have a calendar, a shopping list, and a movie list associated with their account. These may be available targets for user requested actions. For example, if a user says “add it to my list” (where “it” refers to a movie that has just been displayed on the user's device), the entity mention “my list” may be resolved to the target “movie list” using contextual information from previous turns of dialog.

Named entity recognition (NER) is a technique used to identify segments of named entities in text data and to categorize the named entities into various predefined classes. Categorization of named entities into such classes is often referred to as “tagging” the named entities. In this context, “NER tags” are metadata that designates a particular class to a named entity. In text, named entities refer to terms that represent objects such as people, places, organizations, locations, movies, artists, items, etc. In addition, named entities may refer to the endpoints and/or targets previously described. For example, the statement, “Add the movie to my movie list” may include two named entities “the movie” and “my movie list.” “The movie” may be tagged with the NER tag “movie” (or similar), while “my movie list” may be tagged with the NER tag “list” (referring to a potential target).

Entity resolution (ER) refers to disambiguation of an entity (e.g., a named entity in text) according to records stored in memory (e.g., in a database, on a website, in a contextual dialog history, etc.). For example, if text includes the proper noun “London,” ER may be used to perform disambiguation to determine whether to link the named entity to a database entry for London in Ontario or a database entry for London in the United Kingdom. In various examples, the NER classes may be used during ER processing to disambiguate between multiple entities. In the above example, the NER tag “movie” may be contextually resolved using a dialog history to resolve the entity to the specific movie ID (e.g., the movie that was recommended to the user during the past dialog turn). Similarly, the NER tag “list” may be resolved to listID_account1234 as this may have been a target for the particular user account retrieved during step 3.

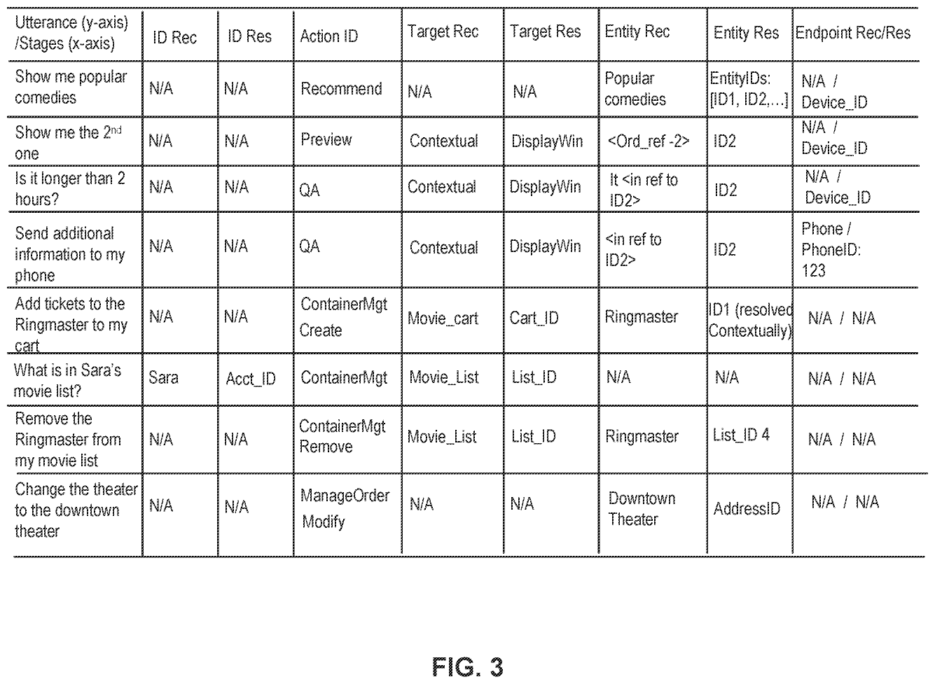

After retrieval of the relevant action data (and/or of action identifier data identifying the relevant action data), available endpoints, available targets, and/or account information using the input request (at step (3)), the LM orchestrator 102 may generate prompt data including the retrieved information along with specific instructions for the LM 104 to recognize the relevant entities. It should be noted that some input requests may not implicate a specific endpoint or target. As such, no endpoints or targets may be retrieved during step (3) irrespective of whether such endpoints or targets are stored in memory for a specific account ID. For example, a user request of “add that song to my queue” may not implicate any specific endpoint device, and thus no endpoint may be retrieved from the registry for this specific query irrespective of the fact that the user may have several endpoints available (which may be retrieved for other queries). Examples are described in further detail below in reference to FIG. 3.

The specific prompt data at step (4) may vary according to the desired implementation. Generally, the prompt data may include the input request and the retrieved action data. Optionally, the prompt data may include available targets or endpoints, if any. In some examples, the action data may include exemplars, API descriptions, required and/or optional parameters for the action data, etc. The prompt data instructs the LM 104 to perform NER to recognize any named entities in the input request, and to determine the required and/or optional entities needed by the action data in order to execute the action.

The LM 104 may recognize the entities included in the input request and the optional and/or required entities for the given action. For example, for the first utterance “What are some popular comedies” in FIG. 3, the LM orchestrator 102 may generate prompt data that includes the input request “What are some popular comedies” the action data identifier (e.g., the Recommend action, which may include action descriptions, exemplars, required/optional parameters, etc.). The LM 104 may recognize the entity “popular comedies” from the input request. The Recommend action may require a description of the content to be recommended. The LM 104 may determine, using the latent information learned by the LM 104 during training as well as potentially the exemplars and/or descriptions of the Recommend action data, to determine that “popular comedies” is a description of the type of content that is to be recommended. In this example, the input request has not specified a particular account or identity, a particular target, or a particular endpoint (on which the “popular comedies” are to be displayed). Accordingly, the LM 104 may not recognize any such entities (since they are not mentioned).

After recognizing the entities in the input request and/or any required entities in the action data, the LM 104 may generate instructions to resolve the recognized entities and may send the instructions to the LM orchestrator 102. The LM orchestrator 102 may send the NER tags, the input request, the action data, and/or any relevant context (e.g., dialog history including actions taken by the LM 104 during past iterations of the dialog session) to the entity information retrieval component 108.

The entity information retrieval component 108 may attempt to resolve the named entities using various resolver components, such as the keyword resolver 110, the ordinal resolver 116, and/or the evidence insights resolver 120. The entity information retrieval component 108 may select the appropriate resolvers based on the input request, the action data, and/or the context available. For example, ordinal resolver 116 may be employed when the input request includes an ordinal reference. In general, resolvers of the entity information retrieval component 108 may be used to retrieve data related to specific entities for the various classes of entities recognized by the LM 104. For example, for the recognized entity “fishing rods”, the entity information retrieval component may use the keyword resolver 110 to determine content identifiers (e.g., item IDs) related to specific instances of fishing rods.

Referring to FIG. 3, the utterances along the left-most column may be sequential utterances of a dialog session. Initially, the input request may be “what are some popular comedies.” The LM 104 may pass the NER tag “popular comedies” to the entity information retrieval component 108. The input request “what are some popular comedies” does not include any ordinal references. In addition, since this is the first utterance in the dialog, there may be no previously-retrieved evidence for the evidence insight resolver 120 to use. Accordingly, the entity information retrieval component 108 may select the keyword resolver 110 and may attempt to resolve “popular comedies” to specific entities. The keyword resolver 110 may initially attempt contextual retrieval to resolve the specific entities from context (e.g., a previous turn of dialog in which the user has listed their favorite comedies, a list of comedies generated by the account, etc.). However, in the current example, contextual information that may be used to resolve “popular comedies” may not be available. Accordingly, the keyword resolver 110 may use targeted keyword search 114. This may include performing a keyword search for popular comedies from a website, online search engine, previously-generated list, search history, etc. In the example of FIG. 3, the keyword resolver 110 is able to resolve the recognized entity “popular comedies” into the set of movie IDs [ID1, ID2, . . . ]. After resolution of the recognized entities, the action data may be carried out by the LM-based content retrieval system 100, as described in further detail below.

The next turn of input dialog in FIG. 3 comprises the input request “Show me the second one.” The retrieved action data comprises the “preview” action (e.g., an action in which a detailed view of content is displayed on a screen). In this example, the LM 104 may recognize the named entity “second one” in the input request and may generate an instruction for the entity information retrieval component 108 to resolve the recognized entity. The entity information retrieval component 108 may detect the ordinal reference (“second”) and may thus use the ordinal resolver 116 to resolve the entity. The ordinal resolver 116 may use the contextual data search 118 including the prior output list of popular comedies (i.e., movie IDs [ID1, ID2, . . . ]) and may select the second in the list (movie ID2) as the resolved entity.

In some other examples, a previous turn of dialog may have resulted in information being retrieved about particular content. For example, the user may have said “what is that shoe?” after seeing a shoe displayed on a screen (e.g., after a display action featuring the specific shoe has been performed). In response, the LM-based content retrieval system 100 may display an item detail page including information about the shoe and/or a website describing the shoe. Thereafter, the user may follow up with the question “Is it waterproof?” In this case, after resolving the named entity “it” to the previously-referred to shoe (e.g., using the keyword resolver 110 (a keyword resolver tool) to perform the contextual data search 112 to determine that “it” refers to a shoe previous resolved in the dialog), the entity information retrieval component 108 may determine that a detail page and/or website may be used to provide this information (whether the detail page and/or website were previously loaded or not). The entity information retrieval component 108 may select the evidence insights resolver 120 to determine that the website and/or detail page includes descriptions of the shoe as being waterproof (or not). For example, the contextual data search 122 may determine that a previously-retrieved website and/or detail page is cached. Alternatively, the evidence insights resolver 120 may perform a targeted search (e.g., using the search query waterproof and the shoe ID) to retrieve information from the web and/or from a catalog describing the requested feature. The evidence insights resolver 120 may often be used after resolving another entity to determine additional information about that entity. However, in some cases, the evidence insights resolver 120 may be used in tandem with another resolver. For example, a user may ask, “Is Brand X smartphone dust resistant?” The keyword resolver 110 may be used to resolve the entity Brand X smartphone, while the evidence insights resolver 120 may search for information about the Brand X smartphone that mention dust and/or dust resistance (e.g., performing a web search, a search of user reviews on an e-commerce site, etc.).

In some examples, a nominal resolver (not shown in FIG. 1) may also be used to determine further information about an output. For example, if a previous list of movies has been output and the user then requests “Show me the one with [actor's name]” the nominal resolver may determine if the currently available information (e.g., contextual metadata for the list of movies) includes actor information. If so, the nominal resolver may output the movie(s) in which the user-specified actor appears. If not, the nominal resolver may retrieve information (e.g., using action data that describes how to retrieve such information for movies) including a list of actors for each movie. The LM 104 may use this information (in a subsequent iteration) to determine in which movies the specified actor appears and may cause those movies to be displayed. Additionally, the ordinal resolver 116 may be used to determine which ordered movie (or movies) in the previously-output list corresponds to movies identified by the nominal resolver as including the actor.

The resolved entities in the input request may be passed back to the LM orchestrator 102. The LM orchestrator 102 may generate additional prompt data for the LM 104 that includes the resolved entities, as well as the input query, the action data, any context data (e.g., previous dialog, data retrieved from registry 160, etc.) and an instruction to generate further instructions to respond to the input request (step (7)). The LM 104 may determine if further information is needed in order to carry out the action. For example, in some cases, the retrieved entity information (e.g., entity information resolved for specific content) may include additional entity mentions that may need to be resolved in order to carry out the user's request. Accordingly, the LM 104 and/or LM orchestrator 102 may iterate until all the required input parameters for the retrieved action data and/or needed to respond to the input request have been determined (e.g., by resolving all relevant entities). Once the LM 104 has resolved all of the relevant entities using the entity information retrieval component 108, the LM 104 may generate an action execution instruction (step (8)). The action execution instruction may be a natural language instruction that may refer to one or more API calls that may be used to carry out the action data using the relevant resolved entities.

The action execution instruction may be sent, at step (9), to the action execution handler 107 (an action execution component), which may generate the computer-executable instructions used to carry out the actions represented by the action data. In various examples, the action execution handler 107 may execute on the endpoint device and/or the target. In some further examples, the action execution handler 107 may perform a check to ensure that the response is unbiased (e.g., toward protected classes), non-harmful, profanity free, etc., prior to execution. In some examples, after executing the action, control may be passed back to the LM 104 to determine how to output the action result to the user in a conversational manner. For example, if the user requested a list of popular comedies, as discussed above, rather than outputting only the titles of each movie, the LM 104 may describe how certain movies are popular with certain age groups, may list the directors and/or actors starring in certain movies, may describe which movies are playing nearby, etc. Further examples of processing by the LM-based content retrieval system 100 are described below in reference to FIG. 3.

FIG. 2 depicts an example LM-based natural language processing flow, in accordance with various aspects of the present disclosure. The example architecture in FIG. 2 includes an LM orchestrator 230 and various other components for determining an output action responsive to a user input. The architecture may further include an action plan execution component 280 and an API provider 290. With reference to FIG. 2, the LM orchestrator 230 may include a preliminary action plan generation component 240, a LM prompt generation component 250, an LM 260, and an action plan generation component 270. In various examples, the LM 260 may be a generative model. The example LM-based natural language processing flow depicted in FIG. 2 may be an example of a generalist natural language processing flow. Accordingly, in various examples, the LM-based natural language processing flow depicted in FIG. 2 may determine, for certain input utterances, that other domain-specific natural language processing flows may be more appropriate for determining an ultimate output action. For example, utterances pertaining to content retrieval may be sent, along with any relevant context, from the LM-based natural language processing flow of FIG. 2 to the LM-based content retrieval system of FIG. 1.

In some examples, the LM 260 may be a transformer-based seq2seq model involving an encoder-decoder architecture. In some such embodiments, the LM 260 may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the LM 260 may be pre-trained with approximately 1 trillion tokens. Being trained on CLM tasks, the LM 260 may be capable of in-context learning. An example of such a LM is Alexa Teacher Model (Alexa™).

In various examples, the input to the LM 260 may be in the form of a prompt (e.g., prompt data). A prompt may be a natural language input, for example, an instruction, for the LM 260 to generate an output according to the prompt. The output generated by the LM 260 may be a natural language output responsive to the prompt. The prompt and the output may be text in a particular spoken language. For example, for an example prompt “how do I cook beans?”, the LM 260 may output a recipe (e.g., a step-by-step process) to cook beans. As another example, for an example prompt “I am hungry. What restaurants in the area are open?”, the LM may output a list of restaurants near the user that are open at the current time. In various examples, the prompt may provide some instructions as to how to decompose a particular request or task and/or how the LM 260 may use certain tools that are available (e.g., via API calls to an API provider 290).

The LM 260 may be configured using various machine learning techniques. For example, in some embodiments, the LM 260 may be configured (e.g., “fine tuned”) using few-shot learning. In few-shot learning, the model learns how to learn to solve the given problem. In this approach, the model is provided with a limited number of examples (i.e., “few shots”) from the new task, and the model uses this information to adapt and perform well on that task. Few-shot learning may require fewer amount of training data than implementing other fine-tuning techniques. For further example, in some embodiments, the LM 260 may be configured using one-shot learning, which is similar to few-shot learning, except the model is provided with a single example. As another example, in some embodiments, the LM 260 may be configured using zero-shot learning. In zero-shot learning, the model solves the given problem without examples of how to solve the specific/similar problem and just based on the model's training dataset. In this approach, the model is provided with data sampled from a class not observed during training, and the model learns to classify the data.

The LM orchestrator 230 may be configured for generating the prompt to be used by the LM 260 to determine an action responsive to user input. As shown in FIG. 2, the LM orchestrator 230 receives (at step 1) input query 106. In some instances, the input query 106 may correspond to a text or tokenized representation of a user input. For example, prior to the LM orchestrator 230 receiving the input query 106, another component (e.g., an ASR component) may receive audio data representing the user input. The ASR component may perform ASR processing on the audio data to determine ASR output data corresponding to the user input. As previously described, an ASR component may determine ASR data that includes an ASR N-best list including multiple ASR hypotheses and corresponding confidence scores representing what the user may have said. The ASR hypotheses may include text data, token data, etc. as representing the input utterance. The confidence score of each ASR hypothesis may indicate the ASR component's level of confidence that the corresponding hypothesis represents what the user said. The ASR component may also determine token scores corresponding to each token/word of the ASR hypothesis, where the token score indicates the ASR component's level of confidence that the respective token/word was spoken by the user. The token scores may be identified as an entity score when the corresponding token relates to an entity. In some instances, the input query 106 may include a top scoring ASR hypothesis of the ASR data.

As illustrated in FIG. 2, the input query 106 may be received at the preliminary action plan generation component 240 and the LM prompt generation component 250 of the LM orchestrator 230. The preliminary action plan generation component 240 processes the input query 106 to generate prompt generation action plan data 245 corresponding to an instruction(s) (e.g., a request(s)) for one or more portions of data usable to generate a language model prompt for determining an action responsive to the user input). The preliminary action plan generation component 240 and/or the LM prompt generation component 250 may also be implemented as LMs or other language models configured to augment the input query 106 with relevant information that assists the LM 260 in completing the task represented by the input query 106. In some examples, the preliminary action plan generation component 240 may determine one or more portions of data that is determined to be relevant for processing of the user input. The one or more portions of data may represent one or more actions (e.g., API definitions), one or more exemplars corresponding to the actions (e.g., example model outputs including an appropriate use of the API), one or more device states corresponding to one or more devices associated with the user input, and/or one or more other contexts associated with the user input. For example, if the input query 106 represents a user input of “please turn on the kitchen lights every morning at 7 am,” then the preliminary action plan generation component 240 may determine prompt generation action plan data 245 representing instructions for one or more actions (e.g., API definitions) related to turning on the kitchens lights every morning, one or more exemplars corresponding to the related actions, one or more device states corresponding to one or more devices associated with the “kitchen lights”, and one or more other contexts. For further example, if the input query 106 represents a user input of “What is the elevation of Mt. Everest,” then the preliminary action plan generation component 240 may determine prompt generation action plan data 245 representing instructions for one or more actions (e.g., API definitions, specifications, schemas) related to the user input and one or more exemplars corresponding to the related actions, as other information, such as devices states or other contextual information (user profile information, device profile information, weather, time of day, historical interaction history) may not be relevant.

In some examples, the prompt generation action plan data 245 may include one or more executable API calls usable for retrieving the one or more portions of data from the corresponding component. For example, instructions included in the prompt generation action plan data 245 may include “FETCH_API,” “FETCH_EXEMPLAR,” “FETCH DEVICE_STATE,” “FETCH_CONTEXT,” etc., along with optional API arguments/inputs. In some embodiments, the prompt generation action plan data 245 may also include the input query 106. The prompt generation action plan data 245 may be sent (at step 2) to the action plan execution component 280.

In some examples, the preliminary action plan generation component 240 may be configured to process the input query 106 to determine a representation of the user's request. In various examples, the representation of the user's request may be a reformulation of the user's request. For example, the if the input query 106 represents a user input of “I have always wanted to travel to Japan, I have heard it's beautiful. How tall is Mt. Fuji?”, then the preliminary action plan generation component 240 may determine the representation of the user's request as being “How tall is Mt. Fuji,” or the like. The preliminary action plan generation component 240 may generate the prompt generation action plan data 245 using the determined representation of the user's request.

In some examples, the preliminary action plan generation component 240 may implement one or more machine learning (ML) models. A first ML model(s) may be configured to take as input the input query 106 and generate a representation of the user's request. For example, the ML model may be a text summarization model or a text rewrite model. A second ML model (or the first ML model) may be configured to take as input the representation of the user's request (or the input query 106) and determine the one or more portions of data relevant for processing of the user input. For example, the second ML model may be a classifier trained to classify the user's request (or the input query 106) to determine data (or types of data) relevant to the processing of the user input (e.g., one or more related actions (e.g., API definitions), one or more exemplars corresponding to the one or more related actions, one or more device states corresponding to one or more related devices, one or more related contexts, etc.)

In other embodiments, the preliminary action plan generation component 240 may be an LM, similar to the LM 260. In such embodiments, the architecture (e.g., LM 80) may include a further component configured to generate a prompt to be provided to the LM (e.g., similar to the LM prompt generation component 250) or the prompt may be generated by the LM prompt generation component 250. The component may generate a prompt (e.g., according to a template) including the input query 106 and instructions to determine the one or more portions of data (or types of data) relevant to the processing of the user input. The LM may process the prompt and generate model output data representing the one or more portions of data (or types of data). The preliminary action plan generation component 240 may process the model output data to determine the prompt generation action plan data 245.

The action plan execution component 280 may process the prompt generation action plan data 245 to execute the one or more instructions to retrieve/receive data corresponding to the user input and that may be used to generate the language model prompt. As shown in FIG. 2, the action plan execution component 280 processes the prompt generation action plan data 245 to generate action data 285 representing an action included in the prompt generation action plan data 245 (e.g., a single instruction, such as FETCH_CONTEXT). For example, in the situation where the action is represented by an API call, the action data 285 may represent the action plan execution component 280 executing the API call included in the prompt generation action plan data 245. The action data 285 may be sent (at step 3) to the API provider 290. In the situation where the prompt generation action plan data 245 includes more than one instruction, the action plan execution component 280 may generate more than one instance of action data 285 (e.g., one instance for each instruction included in the prompt generation action plan data 245) and send each instance to the API provider 290.

The API provider 290 may process the (one or more instances of the) action data 285 and cause the retrieval of the (one or more portions of) data associated with the action data 285. The API provider 290 may include a knowledge provider component. The knowledge provider component may include an API retrieval component, an exemplar retrieval component, a device state retrieval component, and an “other” context retrieval component. The knowledge provider component may provide the action data 285 to the component(s) configured to determine the data corresponding to the request(s) represented by the action data 285.

For example, the API retrieval component (not shown) may process the action data 285 to generate API data 292 representing one or more APIs that correspond to an action performable with respect to the user input. For example, if the user input corresponds to “turn on the kitchen light,” the API retrieval component may determine an API usable to control a device and include an API definition corresponding to the API in the API data 292. In some embodiments, the API definition may include one or more API call frameworks for instructing/requesting that the API perform an action (e.g., turn_on_device (device: [device name]), turn_off_device (device: [device name]), set_device_temperature (device: [device name]); temperature: [temperature], set_device_volume (device: [device name]; volume: [volume value]), etc.). In some embodiments, the API definition may include a natural language description of the functionality of the API (e.g., a natural language description of the actions performable by the API/API call framework). For example, for the abovementioned API determined to be associated with the user input of “turn on the kitchen light,” the API definition may further include a natural language description of “used to power on a device.” In some embodiments, the one or more API definitions may be included in the API data 292 based on them being semantically similar to the user input. For example, the API retrieval component may be capable of comparing (e.g., using cosine similarity) (an encoded representation of) the user input to (an encoded representation of) the API definition to determine a semantic similarity between the user input and the API definition (e.g., a semantic similarity between the user input and the natural language description of the functionality of the API included in the API definition). If the API definition is determined to be semantically similar to the user input, then the corresponding API definition may be included in the API data 292. In some embodiments, the API retrieval component may include the top-n identified API definitions in the API data 292. The API data 292 may be sent (at step 4) to the action plan execution component 280 as shown in FIG. 2.

For further example, the exemplar retrieval component may process the action data 285 to generate exemplar data 294 representing one or more exemplars associated with one or more APIs (e.g., the API represented by the API data 292). As used herein, an “exemplar” associated with an API corresponds to an example use of the API (e.g., an example language model output including use of the API (e.g., via a corresponding API call) with respect to a user input, where the user input is similar to the current user input. For example, for an API associated with the API call framework “turn_on_device (device: [device name]),” and the current user input “please turn on the kitchen lights” the exemplar retrieval component may select an exemplar including the example user input of “please turn on the lights” and the API call of “turn_on_device (device=“lights”).” In some embodiments, an exemplar represented in the exemplar data 294 may include an example user input, a natural language description of an action associated with the example user input, an executable API call associated with the example user input and the action associated with the example user input, an example result of the API call, a natural language description of an action to be performed in response to the example result of the API call, and/or an output responsive to the user input. For example, for an API associated with the API call frameworks “Routine.create_turn_on_action (device: str)” and “Routine.create_time_trigger (hour: [hour value])” and the current user input “please turn on the kitchen light everyday at 7 am,” the exemplar retrieval component may select an exemplar representing:

{
User: turn on the kitchen light everyday at 7am
Thought: the customer is trying to create a routine
Action:
Routine.create_routine(trigger=Routine.create_time_trigger(hour=
7), action=Routine.create_turn_on_action(device=″kitchen light″))
Observation: routine created successfully
Thought: time to respond
Response: I have created a routine for you. Anything else?
}

Although not illustrated in FIG. 2, in some embodiments, the API provider 290 and/or a knowledge provider component may provide the exemplar retrieval component with the action data 285 and a list of API call(s) to which the determined exemplars are to be associated (e.g., the API call(s) included in the API data 292). In some embodiments, the one or more exemplars may be included in the exemplar data 294 based on them being semantically similar to the user input. For example, the exemplar retrieval component may be capable of comparing (e.g., using cosine similarity) the current user input to the example user input included in an exemplar to determine a semantic similarity between the current user input and the example user input. If the example user input is determined to be semantically similar to the current user input, then the corresponding exemplar may be included in the exemplar data 294. In some embodiments, the exemplar retrieval component may include the top-n identified exemplars in the exemplar data 294. The exemplar data 294 may be sent (at step 4) to the action plan execution component 280 as shown in FIG. 2.

As another example, a device state retrieval component (not shown in FIG. 2) may process the action data 285 to generate device state data 296 representing one or more states of one or more devices associated with/relevant to the user input (e.g., whether the device is powered on or off, a volume level associated with the device, etc.). For example, if the user input corresponds to “Please turn on the kitchen light,” the device state data 296 may represent the state(s) of one or more devices that are associated with a functionality of turning on a light, are associated with the kitchen, are associated with a user profile of a user who provided the user input, etc. In some embodiments, the device(s) may be determined to be relevant based on a device location(s). For example, devices (e.g., microwave, oven, fridge, smart speaker, etc.) near the user device (e.g., located in the kitchen) that received the user input may be used to determine the device state data 296. In some embodiments, the one or more devices may be determined to be relevant to the user input based on device profile information. For example, the device state retrieval component may be capable of comparing device profile information for a device (e.g., device ID, device group ID, a location associated with the device, etc.) to the user input to determine whether the device is relevant to the user input. In some embodiments, the device state retrieval component may include the top-n identified device states in the device state data 296. The device state data 296 may be sent (at step 4) to the action plan execution component 280 as shown in FIG. 2.

As a further example, a context retrieval component (not shown) may process the action data 285 to generate other context data 48 (apart from the device state data 296, the API data 292, the exemplar data 294, etc.) representing one or more contexts associated with/relevant to the user input. For example, the other context data 48 may represent user profile information (age, gender, associated devices, user preferences, etc.), visual context (e.g., content being displayed by devices associated with the user profile, content being displayed by the user device that captured the user input, etc.), knowledge context (e.g., one or more previous user inputs and/or system generated responses, etc.), time of day, geographic/device location, weather information, etc. In some embodiments, the other context retrieval component may include the top-n identified context in the other context data 48. The other context data 48 may be sent (at step 4) to the action plan execution component 280 as shown in FIG. 2.

In some embodiments, the knowledge provider component may be configured to cause one or more of the API retrieval components, the exemplar retrieval component, the device state retrieval component, and the other context retrieval component to process based on the data output by one or more of the components of the knowledge provider component. For example, if the output of the API retrieval component (e.g., the API data 292) indicates that a related API definition was identified, then the knowledge provider component (or another component) may cause the exemplar retrieval component to process to determine one or more exemplars related to the identified API definitions. For further example, if the output of the API retrieval component (e.g., the API data 292) indicates that a particular API definition was identified (e.g., an API definition for controlling a device), then the knowledge provider component may cause the exemplar retrieval component to process as described above, and may further cause the device state retrieval component and/or the other context retrieval component to process to determine device states for one or more related devices and/or other contextual information based on the identified API definition being associated with controlling a device. In some embodiments, the knowledge provider component may determine to cause the components to process based on instruction(s) included in the action data (e.g., based on a determination made by preliminary action plan generation component 240, as discussed above).

The action plan execution component 280 may send (step 5) the data received from the API provider 290 (e.g., the API data 292, the exemplar data 294, the device state data 296, and the other context data 48) to the LM prompt generation component 250. The LM prompt generation component 250 may be configured to generate prompt data 255 (e.g., using the input query 106, the API data 292, the exemplar data 294, the device state data 296, and/or the other context data 48) to be used by the LM 260.

In some examples, the LM prompt generation component 250 may generate the prompt data 255 representing a prompt for input to the LM 260. In some embodiments, such prompt data 255 may be generated based on combining the input query 106, the API data 292, the exemplar data 294, the device state data 296, and the other context data 48. The prompt data 255 may be an instruction to determine an action(s) responsive to the input query 106 given the other information (e.g., the API data 292, the exemplar data 294, the device state data 296, the other context data 48) included in the prompt data 255. In some embodiments, the LM prompt generation component 250 may also include in the prompt data 255 a sample processing format to be used by the LM 260 when processing the prompt and generating the response. In some embodiments, the prompt data 255 may be generated according to a template format. For example, the prompt data 255 may adhere to a template format of:

{
You have access to the following API's:
[API(s) (e.g., the API data 192)]
Use the following format:
User: the input utterance of a user
Thought: optionally think about what to do
Action: take an action by calling APIs
Observation: what the API execution returns
... (this thought/action/action input/observation can repeat N times)
Thought: done
Response: the proper response to the user (end of turn)
Examples:
[Exemplar(s) (e.g., the exemplar data 294)]
Context: [device state(s) (e.g., the device state data 296)] [other
context(s) (e.g., the other context data 48)]
User: [the user input (e.g., the input query 106)]
}

In some examples, the template format may instruct the LM 260 as to how it should process to determine the action responsive to the user input and/or how it should generate the output including the action response to the user input. For example, as shown in the example above, the format may include the label “User:” labelling the following string of characters/tokens as the user input. For further example, the format may include the label “Thought:” instructing the LM 260 to generate an output representing the determined interpretation of the user input by the LM 260 (e.g., the user is requesting [intent of the user input], the user is trying to [intent of the user Input], etc.) As another example, the format may include the label “Observation:” labeling the following string of characters/tokens as the result of performance of an action determined by the LM 260/the LM 260's interpretation of the result of the performance of the action determined by the LM 260. As a further example, the format may include a label of “Response:” instructing the LM 260 to generate a response (e.g., a natural language output for a user) to the prompt.

Following such a template format, for example, and for a user input of “turn on the living room light” and corresponding API data, exemplar data, device state data, and other context data, the LM prompt generation component 250 may generate example prompt data 255a:

{
You have access to the following API's:
Routine.turn_on_device (device: [device name]) turns a device on.
Use the following format:
User: the input utterance of a user
Thought: optionally think about what to do
Action: take an action by calling APIs
Observation: what the API execution returns
... (this thought/action/action input/observation can repeat N times)
Thought: done
Response: the proper response to the user (end of turn)
Examples:
User: turn on all indoor lights
Thought: the user is trying to turn lights on
Action: turn_on_device (device=″indoor light 1″)
turn_on_device (device=″indoor light 2″)
Observation: success success
Thought: time to respond
Response: Anything else I can help you with?
Context: the user has the following devices, bathroom light,
bedroom light, kitchen light, and living room light.
User: turn on the living room light.
}

In some embodiments, the LM prompt generation component 250 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data may include “Please generate a polite, respectful, and safe response and one that does not violate protected class policy.”

As described above, in some examples, one of the APIs available to the LM orchestrator 230 and/or determined as part of the preliminary action plan generated by the preliminary action plan generation component 240 may be an API associated with the LM-based content retrieval system 100 of FIG. 1. Accordingly, in some instances, the LM 260 may determine that a particular input query 106 is appropriate for processing by the LM-based content retrieval system 100. In such examples, the LM 260 may generate an action plan (based on the knowledge of the API associated with the LM-based content retrieval system 100) that comprises routing the input query 106 and/or any relevant context data 48 to the LM-based content retrieval system 100 for processing as described above in FIG. 1. For example, input queries in which the user wants to retrieve information about a particular content item, input queries in which the user would like to have content recommended, etc., may generally be routed to the LM-based content retrieval system 100 for further processing.

The LM 260 processes the prompt data 255 to generate model output data 265 representing an action responsive to the user input. For example, based on processing the example prompt data provided above, the LM 260 may output model output data 265: {“Thought: the user is trying to turn on the living room light; Action: turn_on_device (device=“living room light”),”} or the like. The model output data 265 is sent (at step 7) to the action plan generation component 270. The action plan generation component 270 may parse the model output data 265 to determine action plan data representing the action generated by the LM 260. For example, for the model output data 265: “Action: turn_on_device (device=“living room light”),” the corresponding action plan data may correspond to “turn_on_device (device=“living room light”)” (e.g., corresponding to the action generated by the LM 260, without the label of “Action”). In some embodiments, the action plan generation component 270 may determine an API call corresponding to the “Action” data included in the model output data 265. For example, in some embodiments, the action plan generation component 270 may fill in the arguments/inputs, if any, for the API call, which may be included in the action plan data. For further example, in some embodiments, the action plan execution component 280 may fill in the arguments/inputs, if any, for the API call.

In some embodiments, the LM orchestrator 230 (e.g., the action plan generation component 270 or another component of the LM orchestrator 230) may determine whether the LM 260 output satisfies certain conditions. Such conditions may relate to checking whether the output includes biased information (e.g., bias towards a protected class), harmful information (e.g., violence-related content, harmful content), profanity, content based on model hallucinations, etc. A model hallucination refers to when a model (e.g., a language model) generates a confident response that is not grounded in any of its training data. For example, the model may generate a response including a random number, which is not an accurate response to an input prompt, and then the model may continue to falsely represent that the random number is an accurate response to future input prompts. To check for an output being based on model hallucinations, the LM orchestrator 230 may use a knowledge base, web search, etc. to fact-check information included in the output.

FIG. 3 depicts a table including input utterances and various intermediate result data determined for the utterance by the LM-based content retrieval system of FIG. 1, in accordance with various aspects of the present disclosure. Continuing the example described above in reference to FIG. 1, for the user input “what are some popular comedies”, the recommend action (a recommendation action) may be retrieved from registry 160 and the recognized entity “popular comedies” may be resolved to the specific movie IDs. Since the user has not specified a target or an endpoint, default targets and/or endpoints may be selected. For example, the default endpoint may be the device on which the user input was received (e.g., Device_ID in FIG. 3). The default target, for content of this type, may be a display window if the endpoint device includes a display or an audio output describing the resolved movie IDs if the device does not include a display, but includes a speaker.

The following utterance “show me the second one” may be received. The action “preview” may be retrieved for this follow-up utterance (which may be part of the same dialog session maintained by the LM orchestrator 102. As previously described, the ordinal resolver 116 (an ordinal resolver tool) may resolve the recognized entity “second one” to the second movie ID in the previously-output list of movies using contextual data search 118. Again, as no endpoint has been specified, the default endpoint (e.g., the device with which the user is interacting in the dialog session) may be used. Although no target has been specified, the target display window may be contextually resolved from the context history. In other words, the same target display window that was previously used to display the list of recommended popular comedies may be used to display the preview of the second movie (movie ID2).

The following utterance “is it longer than 2 hours”? may be used to lookup a question-and-answer action in registry 160. The recognized entity “it” in this utterance may be contextually resolved to movie ID2 using contextual data search 112 and/or 122. In this case, since contextual data may have previously been loaded and/or cached for the movie ID2 (e.g., as a result of the previous Preview action), evidence insights resolver 120 may be used to determine the movie ID2's runtime and the LM 104 may determine whether the runtime is longer than 2 hours. The target may again be contextually resolved as with the prior utterance.

The following utterance “send additional information to my phone” specifies a particular endpoint (i.e., “my phone”). Contextual data search 112 and/or 122 may be used to contextually resolve “additional information” to movie ID2. LM 104 may recognize the endpoint entity “my phone” and this recognized endpoint entity may be resolved to PhoneID123, which may be an available endpoint looked up from registry 160 for the particular user account. The target may be an available target for this particular endpoint (e.g., Phone Display).

In general, the table in FIG. 3 represents a conversational dialog that a user may have with the LM-based content retrieval system 100. Action data for each utterance may be looked up from registry 160 along with relevant targets, identities, and endpoints. The LM 104 may be used to recursively recognize entities (e.g., entities in the input request and/or entities implicated by the action data) and may send the recognized entities to the entity information retrieval component 108 for resolution. In various cases, endpoint entities and/or target entities may be resolved from among the list of available targets/endpoints looked up from registry 160. Additionally, other entities (e.g., content mentions) may be looked up contextually (e.g., from previous turns of dialog) and/or from other sources using the entity information retrieval component 108 (e.g., using an external search tool (e.g., targeted keyword search 114) and/or catalogues (e.g., targeted search 124).

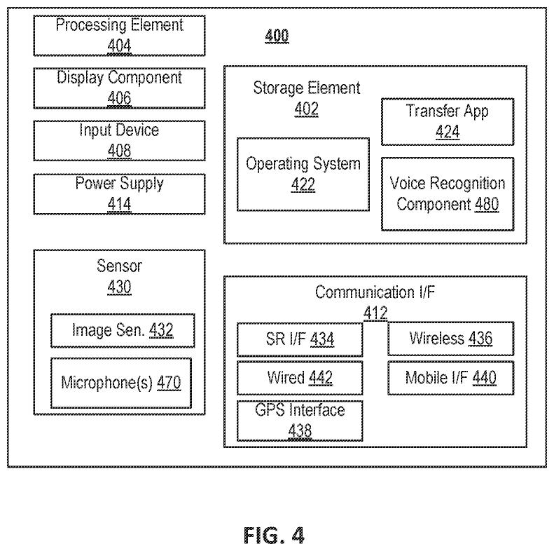

FIG. 4 is a block diagram showing an example architecture 400 of a network-connected device (e.g., a local network-connected device such as natural language processing-enabled device used to receive an input query 106 or another input device) that may be used to implement, at least in part, a natural language processing-enable device configured to receive spoken and/or other natural input commands, in accordance with various aspects of the present disclosure. It will be appreciated that not all devices will include all of the components of the architecture 400 and some user devices may include additional components not shown in the architecture 400. The architecture 400 may include one or more processing elements 404 for executing instructions and retrieving data stored in a storage element 402. The processing element 404 may comprise at least one processor. Any suitable processor or processors may be used. For example, the processing element 404 may comprise one or more digital signal processors (DSPs). In some examples, the processing element 404 may be effective to determine a wakeword and/or to stream audio data to a speech processing system. The storage element 402 can include one or more different types of memory, data storage, or computer-readable storage media devoted to different purposes within the architecture 400. For example, the storage element 402 may comprise flash memory, random-access memory, disk-based storage, etc. Different portions of the storage element 402, for example, may be used for program instructions for execution by the processing element 404, storage of images or other digital works, and/or a removable storage for transferring data to other devices, etc. In various examples, the storage element 402 may comprise one or more components of the LM-based content retrieval system 100.

The storage element 402 may also store software for execution by the processing element 404. An operating system 422 may provide the user with an interface for operating the computing device and may facilitate communications and commands between applications executing on the architecture 400 and various hardware thereof. A transfer application 424 may be configured to receive images, audio, and/or video from another device (e.g., a mobile device, image capture device, and/or display device) or from an image sensor 432 and/or microphone 470 included in the architecture 400. In some examples, the transfer application 424 may also be configured to send the received voice requests to one or more voice recognition servers.

When implemented in some user devices, the architecture 400 may also comprise a display component 406. The display component 406 may comprise one or more light-emitting diodes (LEDs) or other suitable display lamps. Also, in some examples, the display component 406 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 406 may be effective to display content determined provided by a skill executed by the processing element 404 and/or by another computing device.

The architecture 400 may also include one or more input devices 408 operable to receive inputs from a user. The input devices 408 can include, for example, a push button, touch pad, touch screen, wheel, joystick, keyboard, mouse, trackball, keypad, light gun, game controller, or any other such device or element whereby a user can provide inputs to the architecture 400. These input devices 408 may be incorporated into the architecture 400 or operably coupled to the architecture 400 via wired or wireless interface. In some examples, architecture 400 may include a microphone 470 or an array of microphones for capturing sounds, such as voice requests. Voice recognition component 480 may interpret audio signals of sound captured by microphone 470. In some examples, voice recognition component 480 may listen for a “wakeword” to be received by microphone 470. Upon receipt of the wakeword, voice recognition component 480 may stream audio to a voice recognition server for analysis, such as a speech processing system. In various examples, voice recognition component 480 may stream audio to external computing devices via communication interface 412.

When the display component 406 includes a touch-sensitive display, the input devices 408 can include a touch sensor that operates in conjunction with the display component 406 to permit users to interact with the image displayed by the display component 406 using touch inputs (e.g., with a finger or stylus). The architecture 400 may also include a power supply 414, such as a wired alternating current (AC) converter, a rechargeable battery operable to be recharged through conventional plug-in approaches, or through other approaches such as capacitive or inductive charging.

The communication interface 412 may comprise one or more wired or wireless components operable to communicate with one or more other computing devices. For example, the communication interface 412 may comprise a wireless communication module 436 configured to communicate on a network, such as a computer communication network, according to any suitable wireless protocol, such as IEEE 802.11 or another suitable wireless local area network (WLAN) protocol. A short range interface 434 may be configured to communicate using one or more short range wireless protocols such as, for example, near field communications (NFC), Bluetooth, Bluetooth LE, etc. A mobile interface 440 may be configured to communicate utilizing a cellular or other mobile protocol. A Global Positioning System (GPS) interface 438 may be in communication with one or more earth-orbiting satellites or other suitable position-determining systems to identify a position of the architecture 400. A wired communication module 442 may be configured to communicate according to the USB protocol or any other suitable protocol.

The architecture 400 may also include one or more sensors 430 such as, for example, one or more position sensors, image sensors, and/or motion sensors. An image sensor 432 is shown in FIG. 4. An example of an image sensor 432 may be a camera configured to capture color information, image geometry information, and/or ambient light information.

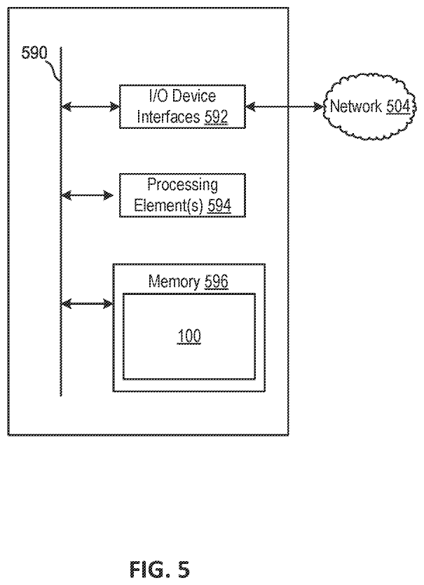

FIG. 5 is a block diagram conceptually illustrating example components of a remote device, such as a computing device executing a particular skill, a computing device executing one or more components of a speech processing system (e.g., ASR processing components, NLU processing components, applicable protocol recognition, etc.) and/or command processing. For example, the various components of FIG. 5 may be used to implement the LM-based content retrieval system 100. Multiple computing devices may be included in the system, such as one speech processing computing device for performing ASR processing, one speech processing computing device for performing NLU processing, one or more skill computing device(s) implementing skills, etc. In operation, each of these devices (or groups of devices) may include non-transitory computer-readable and computer-executable instructions that reside on the respective device, as will be discussed further below. The remote device of FIG. 5 may communicate with one or more other devices over a network 504 (e.g., a wide area network or local area network).

Each computing device of a speech processing system may include one or more controllers/processors 594, which may each include at least one central processing unit (CPU) for processing data and computer-readable instructions, and a memory 596 for storing data and instructions of the respective device. In at least some examples, memory 596 may store, for example, a list of N-best intents data that may be generated for particular request data. In some examples, memory 596 may store machine learning models of the LM 80, such as machine learned models associated with various classifiers and/or natural language inference models (described in reference to FIG. 1), when loaded from memory 596. In various further examples, memory 596 may be effective to store instructions effective to program controllers/processors 594 to perform the various techniques described above in reference to FIGS. 1-3. Accordingly, in FIG. 5, the LM-based content retrieval system 100 for LM processing is depicted as being stored within memory 596, as an example. The memories 596 may individually include volatile random access memory (RAM), non-volatile read only memory (ROM), non-volatile magnetoresistive memory (MRAM), and/or other types of memory. Each computing device of a speech processing system (and/or a component thereof) may also include memory 596 for storing data and controller/processor-executable instructions. Each memory 596 may individually include one or more non-volatile storage types such as magnetic storage, optical storage, solid-state storage, etc. Each computing device of a speech processing system may also be connected to removable or external non-volatile memory and/or storage (such as a removable memory card, memory key drive, networked storage, etc.) through respective input/output device interfaces 592. In various examples, the feature data and/or training data used by the various machine learning models may be stored and/or cached in memory 596.

Computer instructions for operating each computing device of a natural language processing system may be executed by the respective device's controllers/processors 594, using the memory 596 as temporary “working” storage at runtime. A device's computer instructions may be stored in a non-transitory manner in non-volatile memory 596 (e.g., a non-transitory computer-readable memory), memory 596, or an external device(s). Alternatively, some or all of the executable instructions may be embedded in hardware or firmware on the respective device in addition to or instead of software.

Each computing device of the various computing devices described herein may include input/output device interfaces 592. A variety of components may be connected through the input/output device interfaces 592, as will be discussed further below. Additionally, each computing device of a speech processing system may include an address/data bus 590 for conveying data among components of the respective device. Each component within a computing device of a speech processing system may also be directly connected to other components in addition to (or instead of) being connected to other components across the bus 590.

As noted above, multiple devices may be employed in a single system. In such a multi-device system, each of the devices may include different components for performing different aspects of the system's processing. The multiple devices may include overlapping components. The components of a speech processing system, as described herein, are exemplary, and may be located as a stand-alone device or may be included, in whole or in part, as a component of a larger device or system.

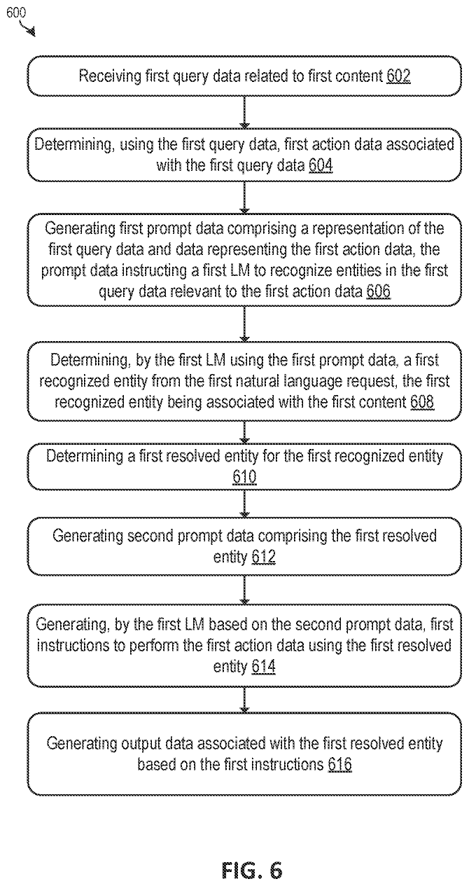

FIG. 6 is a flow chart illustrating an example process 600 for LM-based content retrieval, in accordance with embodiments of the present disclosure. The process 600 of FIG. 6 may be executed by one or more computing devices. The actions of process 600 may represent a series of instructions comprising computer-readable machine code executable by a processing unit of a computing device. In various examples, the computer-readable machine code may be comprised of instructions selected from a native instruction set of the computing device and/or an operating system of the computing device. Various actions in process 600 may be described above with reference to elements of FIGS. 1-5. Although shown in a particular order, the steps of process 600 may instead be performed in a different order. Additionally, various steps may be performed in parallel in various implementations. Further, some steps may be omitted and/or other steps may be added in accordance with the LM-based content retrieval techniques described herein.

Process 600 may begin at action 602, at which first query data related to first content may be received. The first query data may be input by a user (e.g., typed) and/or a transcription of user speech (e.g., a spoken request). The first query data may be data related to retrieval of content and/or performing some action with respect to previously-retrieved content. In various examples, an LM-based processing system may route the first query data from a general natural language processing system (such as the LM-based natural language processing system depicted in FIG. 2) to the LM-based content retrieval system 100 of FIG. 1 based on a determination that the first query data relates to content retrieval and may be better handled by the LM-based content retrieval system 100.

Processing may continue at action 604, at which first action data associated with the first query data may be determined. For example, action data may be looked up from registry 160. The action data may comprise one or more actions that may be taken in order to perform the requested action related to the first content.

Processing may continue at action 606, at which first prompt data may be generated. The first prompt data may include a representation of the first query data and data representing the first action data. The first prompt data may instruct a first LM to recognize entities in the first query data relevant to the first action data. In various examples, in addition to the first query data and the first action data, the first prompt data may include information about available endpoints and/or targets looked up from registry 160 for the first query data.

Processing may continue at action 608, at which the first LM may use the first prompt data to determine a first recognized entity from the first natural language request. The first recognized entity may be associated with the first content. For example, if the user request is “show me some party favors”, “party favors” may be recognized as an entity by the first LM (e.g., LM 104).

Processing may continue at action 610, at which a first resolved entity may be determined for the first recognized entity. For example, as described above, the LM 104 may generate instructions to resolve the first recognized entity (e.g., “party favors”). The LM orchestrator 102 may send the first recognized entity to the entity information retrieval component 108. The entity information retrieval component 108 may determine a strategy for resolving the entity. In the current example, the first query data may be an initial query in a dialog. Accordingly, the entity information retrieval component 108 may determine that “party favors” cannot be contextually resolved from past turns of the dialog. In this example, the entity information retrieval component 108 may use the keyword resolver 110 and the targeted keyword search 114 to search a list, a search engine, user search history, etc. to resolve party favors to one or more resolved entities (e.g., Brand X Potato Chips, Funtime Snack Bars, etc.).

Processing may continue at action 612, at which second prompt data comprising the first resolved entity may be generated. The second prompt data may instruct the LM 104 to determine what other entities are required to respond to the first query data given the results determined at action 610. In the current example, the action data may only require a list of content (e.g., the resolved entities Brand X Potato Chips, Funtime Snack Bars, etc.). However, in other examples, the LM 104 may need to recognize other entities on the basis of the returned results.

In the current example, processing may continue at action 614, at which the first LM may generate, based on the second prompt data, first instructions to perform the first action data using the first resolved entity. For example, the first LM may generate instructions (e.g., natural language instructions) to output the list of resolved entities for the request “show me some party favors.” The first LM may generate instructions that the output should be displayed since the user requested that the results be shown.

Processing may continue to action 616, at which output data may be generated associated with the first resolved entity based on the first instructions. For example, the first instructions may be sent to the action execution handler 107 which may generate computer-executable instructions in response. In this example, the computer executable instructions may cause the user input device that received the first query data to receive the list of resolved content and display the different items on a display of the user input device.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and consequently, are not described in detail herein.

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A computer-implemented method comprising:
receiving first query data comprising a first natural language request to recommend content of a first type;
performing a lookup using the first query data to determine a first action identifier associated with a first recommendation action;
generating, by a large language model (LLM) orchestrator, first prompt data comprising the first query data and the first recommendation action, wherein the first prompt data instructs a first LLM to recognize entities in the first query data relevant to the first recommendation action;
determining, by the first LLM using the first prompt data, a first recognized entity in the first natural language request, wherein the first recognized entity corresponds to the content of the first type;
sending, by the first LLM to the LLM orchestrator, a request to resolve the first recognized entity;
determining, using a first keyword resolver tool, a first content identifier related to a first instance of the content of the first type and a second content identifier related to a second instance of the content of the first type;
generating, by the LLM orchestrator, second prompt data comprising the first content identifier and the second content identifier;
generating, by the first LLM using the second prompt data, first instructions to perform the first recommendation action using the first content identifier and the second content identifier;
receiving, by an action execution component, the first instructions; and
executing the first recommendation action by the action execution component, wherein the executing the first recommendation action comprises causes an output of a list comprising data representing the first instance of the content of the first type and data representing the second instance of the content of the first type.

2. The computer-implemented method of claim 1, further comprising:
searching, by the first keyword resolver tool using the first recognized entity, first historical context data comprising a prior input natural language request and a prior response to the prior input natural language request; and
determining, by the first keyword resolver tool, that the prior response comprises the first instance of the content of the first type and the second instance of the content of the first type, wherein the determining the first content identifier and the second content identifier comprises resolving the first recognized entity using the first historical context data.

3. The computer-implemented method of claim 1, further comprising:
receiving second query data comprising a second natural language request that requests a display of content in the list, wherein the second natural language request identifies the content in the list using an ordinal reference;
performing a lookup using the second query data to determine a second action identifier associated with a display action;
generating, by the LLM orchestrator, third prompt data comprising the second query data and the display action, wherein the third prompt data instructs the first LLM to recognize entities in the second query data relevant to the display action;
determining, by the first LLM using the third prompt data, a second recognized entity in the second natural language request, wherein the second recognized entity corresponds to the content in the list;
sending, by the LLM to the LLM orchestrator, a request to resolve the second recognized entity; and
determining, using an ordinal resolver tool, the second content identifier based on an order of output of the second instance of the content of the first type in the list corresponding to the ordinal reference.

4. The computer-implemented method of claim 1, further comprising:
receiving, the first query data, by a first natural language processing system;
determining, by a second LLM of the first natural language processing system, a first domain associated with the first query data; and
sending the first query data to a domain-specific processing system associated with the first domain, the domain-specific processing system comprising the first LLM and the LLM orchestrator.

5. A method comprising:
receiving first query data comprising a first request related to first content;
determining, using the first query data, first action data associated with the first query data;
generating first prompt data comprising a representation of the first query data and data representing the first action data, wherein the first prompt data instructs a first language model (LM) to recognize entities in the first query data relevant to the first action data;
determining, by the first LM based at least in part on the first prompt data, a first recognized entity from the first request, wherein the first recognized entity is associated with the first content;
generating, by the first LM, a request to resolve the first recognized entity;
determining a first resolved entity for the first recognized entity;
generating second prompt data comprising the first resolved entity;
generating, by the first LM based at least in part on the second prompt data, first instructions to perform at least one action associated with the first action data using the first resolved entity; and
generating output data associated with the first resolved entity based at least in part on the first instructions.

6. The method of claim 5, further comprising:
performing a lookup of a first data store using the first query data to retrieve the first action data, wherein the first action data comprises a set of predefined tasks defined for compliance with a set of rules.

7. The method of claim 5, further comprising:
determining, using the first query data, a target for the first action data, wherein the target specifies a predefined data structure that is acted upon using the first action data.

8. The method of claim 5, further comprising:
determining, using the first query data, an endpoint for the first action data, wherein the endpoint defines a device for outputting the output data; and
sending the output data to the endpoint.

9. The method of claim 5, further comprising:
sending data representing the first recognized entity to an entity information retrieval component;
determining, by the entity information retrieval component, at least a first keyword of the first recognized entity;
determining an account associated with the first query data; and
determining the first resolved entity by searching a list or history associated with the account, wherein the first resolved entity comprises identifier data identifying an instance of the first content.

10. The method of claim 5, further comprising:
determining that the first request comprises an ordinal reference; and
determining the first resolved entity by searching a list of content output prior to receiving the first query data using the ordinal reference, wherein the first resolved entity comprises identifier data identifying an instance of the first content.

11. The method of claim 5, further comprising:
sending data representing the first recognized entity to an entity information retrieval component;
determining, by the entity information retrieval component, at least a first keyword of the first recognized entity;
searching, using at least the first keyword, first historical context data comprising a prior input request and a prior response to the prior input request; and
determining the first resolved entity based at least in part on a correspondence between at least the first keyword and a previously-resolved entity present in the prior input request and the prior response.

12. The method of claim 5, further comprising:
receiving, the first query data, by a first natural language processing system;
determining, by a second LM of the first natural language processing system, a first domain associated with the first query data; and
sending the first query data to a domain-specific processing system associated with the first domain, the domain-specific processing system comprising the first LM.

13. A system comprising:
at least one processor; and
non-transitory computer-readable memory storing instructions that, when executed by the at least one processor, are effective to:
receive first query data comprising a first request related to first content;
determine, using the first query data, first action data associated with the first query data;
generate first prompt data comprising a representation of the first query data and data representing the first action data, wherein the first prompt data instructs a first language model (LM) to recognize entities in the first query data relevant to the first action data;
determine, by the first LM based at least in part on the first prompt data, a first recognized entity from the first request, wherein the first recognized entity is associated with the first content;
generate a request to resolve the first recognized entity;
determine a first resolved entity for the first recognized entity;
generate second prompt data comprising the first resolved entity;
generate, by the first LM based at least in part on the second prompt data, first instructions to perform at least one action associated with the first action data using the first resolved entity; and
generate output data associated with the first resolved entity based at least in part on the first instructions.

14. The system of claim 13, the non-transitory computer-readable memory storing further instructions that, when executed by the at least one processor, are further effective to:
perform a lookup of a first data store using the first query data to retrieve the first action data, wherein the first action data comprises a set of predefined tasks defined for compliance with a set of rules.

15. The system of claim 13, the non-transitory computer-readable memory storing further instructions that, when executed by the at least one processor, are further effective to:
determine, using the first query data, a target for the first action data, wherein the target specifies a predefined data structure that is acted upon using the first action data.

16. The system of claim 13, the non-transitory computer-readable memory storing further instructions that, when executed by the at least one processor, are further effective to:
determine, using the first query data, an endpoint for the first action data, wherein the endpoint defines a device for outputting the output data; and
send the output data to the endpoint.

17. The system of claim 13, the non-transitory computer-readable memory storing further instructions that, when executed by the at least one processor, are further effective to:
send data representing the first recognized entity to an entity information retrieval component;
determine, by the entity information retrieval component, at least a first keyword of the first recognized entity;
determine an account associated with the first query data; and
determine the first resolved entity by searching a list or history associated with the account, wherein the first resolved entity comprises identifier data identifying an instance of the first content.

18. The system of claim 13, the non-transitory computer-readable memory storing further instructions that, when executed by the at least one processor, are further effective to:
determine that the first request comprises an ordinal reference; and
determine the first resolved entity by searching a list of content output prior to receiving the first query data using the ordinal reference, wherein the first resolved entity comprises identifier data identifying an instance of the first content.

19. The system of claim 13, the non-transitory computer-readable memory storing further instructions that, when executed by the at least one processor, are further effective to:
send data representing the first recognized entity to an entity information retrieval component;
determine, by the entity information retrieval component, at least a first keyword of the first recognized entity;
search, using at least the first keyword, first historical context data comprising a prior input request and a prior response to the prior input request; and
determine the first resolved entity based at least in part on a correspondence between at least the first keyword and a previously-resolved entity present in the prior input request and the prior response.

20. The system of claim 13, the non-transitory computer-readable memory storing further instructions that, when executed by the at least one processor, are further effective to:
receive, the first query data, by a first natural language processing system;
determine, by a second LM of the first natural language processing system, a first domain associated with the first query data; and
send the first query data to a domain-specific processing system associated with the first domain, the domain-specific processing system comprising the first LM.
